(19) United States
(12) Patent Application Publication
(10) Pub. No.: US 2023/0147587 A1
(43) Pub. Date: May 11, 2023

(54) SYSTEM AND METHOD OF BUILDING A THREE-DIMENSIONAL MODEL OF A PARTIALLY OBSTRUCTED SURFACE AREA

(71) Applicant: Mike Jay Meier, Chatsworth, GA (US)

(72) Inventor: Mike Jay Meier, Chatsworth, GA (US)

(21) Appl. No.: 18/153,054

(22) Filed: Jan. 11, 2023

Related U.S. Application Data
(60) Provisional application No. 63/278,344, filed on Nov. 11, 2021.

(51) Int. Cl. G06T 3/40; G06T 7/33; G06T 17/00; G01C 11/02

(52) U.S. Cl. CPC G06T 3/4038; G06T 7/33; G06T 17/00; G01C 11/02; G06T 2207/30204; G06T 2200/08

(57) ABSTRACT

A method of building a three-dimensional model of a partially obstructed surface area. The method includes defining the boundary of the surface area and subsections thereof using boundary markers having a preconfigured pattern of location points. An orientation tool may be disposed in each subsection when images are captured thereof. The number and type of captured images are based on the degree of obstruction so that the acquired location and orientation data may be integrated into an internal three-dimensional model.

### CROSS-REFERENCE TO RELATED APPLICATION

This application claims the benefit of priority of U.S. provisional application No. 63/278,344 filed 11 Nov. 2021, the contents of which are herein incorporated by reference.

### BACKGROUND OF THE INVENTION

The present invention relates to photogrammetry and modeling surface areas and, more particularly, a method of building a three-dimensional model of obstructed and partially obstructed surface areas.

The design of flooring in a boat can be tricky as all the flooring pieces are typically not visible because of obstructions (hardware) that prevents an unobstructed view of the floor, which in turn limits the value of captured images for developing a three-dimensional model of the floor for later remotely designing the covering for the floor.

Current methods for rendering high fidelity computer models of these partially obstructed surface areas, from which a covering designer may work from, are too cumbersome and complicated. Current systems use equipment that is easily disturbed while being used, rendering its acquired data useless. Other systems use a process that is difficult to learn and execute and does little to ensure that proper photos are taken. As a result, people using the old methods often move equipment during the process, rendering them useless. Also, the process is so difficult to learn and utilize that most give up on it.

As can be seen, there is a need for a method of building a three-dimensional model of a partially obstructed surface area which eliminates most of the required equipment through a process that is significantly easier to understand and apply than the prior art yet ensures that all required images are captured for modelling.

### SUMMARY OF THE INVENTION

In one aspect of the present invention, a method of acquiring photogrammetric data includes the following: defining a plurality of subsections of the surface area with boundary markers; placing an orientation tool within one of the plurality of subsections; and capturing, by way of an image capturing device, a plurality of images of one of the plurality of subsections, wherein a quantity and vantage points of the plurality of images for each subsection is based on whether the subsection is an unobstructed subsection, a partially obstructed subsection, or a wholly obstructed subsection.

In another one aspect of the present invention, the method of acquiring photogrammetric data further includes wherein each subsection is surrounded on at least three sides; further defining a boundary of the surface area with the boundary marker, wherein the unobstructed subsection is defined by approximately zero percent of circumscribed surface having an obstruction thereon, wherein the partially obstructed subsection is defined by approximately ten to ninety percent of circumscribed surface having an obstruction thereon, wherein the wholly obstructed subsection is defined by approximately one hundred percent of circumscribed surface having an obstruction thereon, wherein the wholly obstructed subsection is defined by approximately one hundred percent of circumscribed surface having an obstruction thereon; and further including placing a numbered marker within each of the plurality of subsections, wherein the plurality of subsections comprises at least one unobstructed subsection, at least one partially obstructed subsection, and at least one wholly obstructed subsection, wherein the boundary marker comprises location data points; and further comprising a photogrammetry software application configured to stitch together the plurality of subsections by aligning location data points of contiguous subsections.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention.

FIG. 2 is a continuation of FIG. 1.

FIG. 3 is a detailed top plan view of an exemplary embodiment of the boundary marker of the present invention, in certain embodiments, the pattern of dots 11 and marks 13 may repeat every 7.5 inches.

FIG. 4 is a detailed top plan view of an exemplary embodiment of the orientation tool of the present invention.

FIG. 5 is a schematic view of an exemplary embodiment of the present invention, illustrating a method of capturing location data of an unobstructed view.

FIG. 6 is a schematic view of an exemplary embodiment of the present invention, illustrating a method of capturing location data of a partially obstructed view.

FIG. 7 is a schematic view of an exemplary embodiment of the present invention, illustrating a method of capturing location data of a wholly obstructed view.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

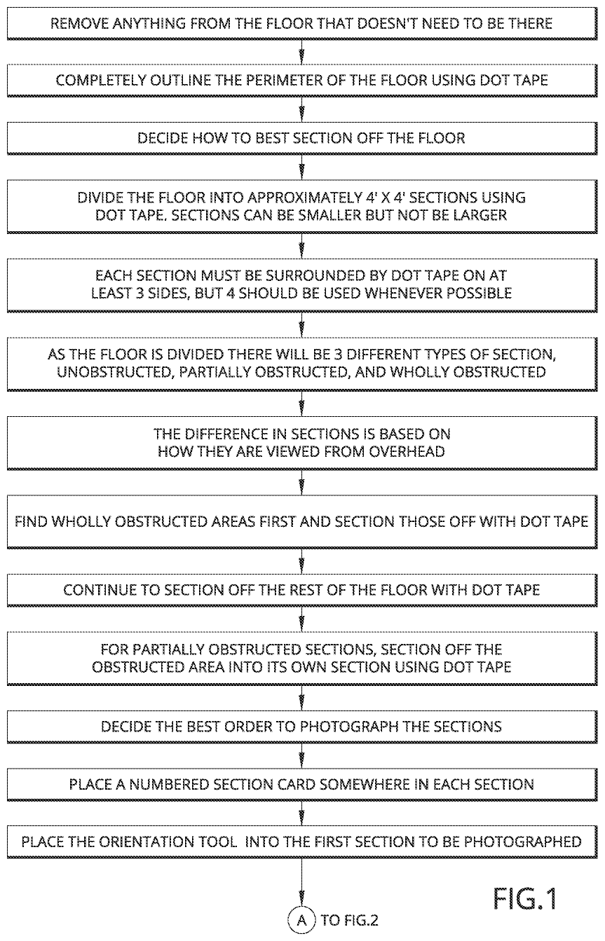

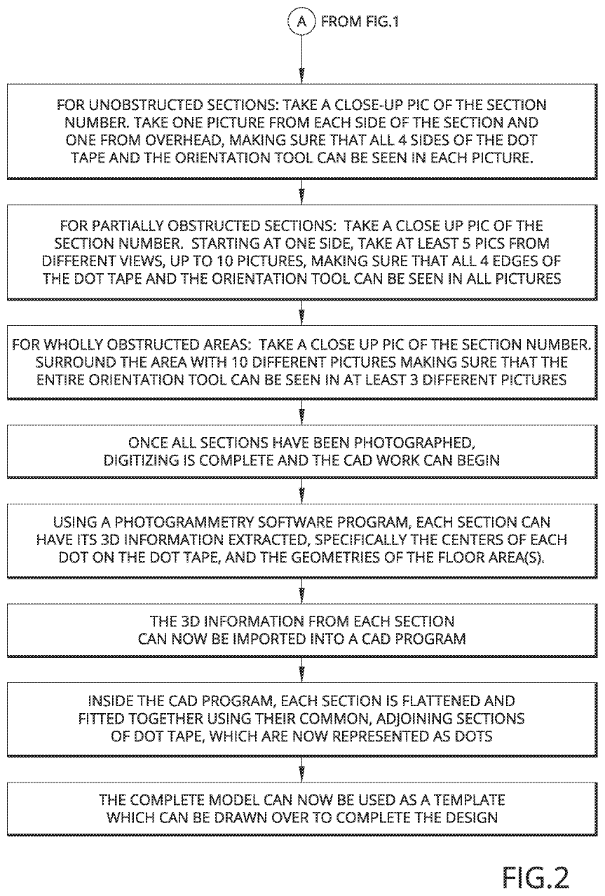

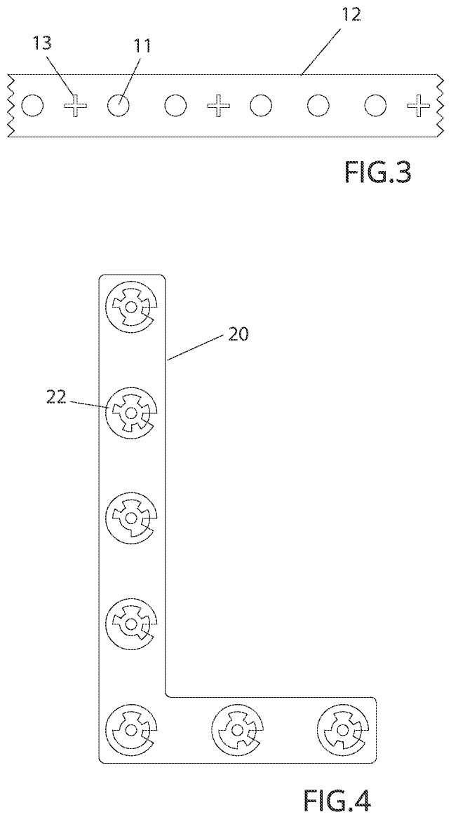

Referring now to FIGS. 1 through 7, the present invention may include a method for photo digitizing an environment or surface area have varying degrees of occlusion (e.g., a floor with objects, such as furniture, thereon), whereby the resulting three-dimensional model and displayed rendering of the surface area (e.g., floor) is devoid of objects.

The method embodies a process of placing boundary markers along a surface area to divide the surface area into a plurality of subsections 10 that are categorized as an unobstructed view, a partially obstructed view, or a wholly obstructed view. The categories of unobstructed views are defined in part by the presence and/or percentage of obstacles 16 (e.g., the piece of furniture) along the surface area as viewed and determined by a top plan (“overhead”) view. Boundary markers 12 may be used to define the bounds of the surface area and subsections 10 thereof, wherein the boundary markers 12 provide a series of location points, such as predetermined spaced apart location dots 11 and/or location marks 13. Within each subsection 10 a numerical marker 30 may also be placed. Likewise, within each subsection 10 one or more orientation tool 20 may be placed (so as not to be occluded by any obstruction 16 from the top plan view and any relevant elevation and/or perspective views), wherein each orientation tool 20 provides a plurality of orientation reticles 22.

For each subsection 10, location data is acquired through capturing images by an image capture device 14. Each captured image may be a “location frame”, and each location frame provides a location data set in the form of the location dots 11 and marks 13 and the orientation reticles 22 identifiable in the capture device's field of view/location frame. The raw location data set may be recorded on the image capture device 14 as a data log as the user takes pictures from predetermined vantage points of the environment containing the surface area desired to be rendered into a model and a floor plan layout on a display.

The system of the present invention may include at least one computing device with a user interface. The computing device may include any computer including, but not limited to, a desktop, laptop, and smart device, such as, a tablet and smart phone. The computing device includes a program product including a machine-readable program code for causing, when executed, the computer to perform steps. The program product may include software which may either be loaded onto the computing device or accessed by the computing device. The loaded software may include an application on a smart device. The software may be accessed by the computing device using a web browser. The computer may access the software via the web browser using the internet, extranet, intranet, host server, internet cloud and the like.

The method embodied by the present invention may be further executed through a software application running on a mobile computing device provisioned with an image capturing component and/or video input component, thereby rendering it an image capturing device 14.

The above-mentioned data log may be a file stored on the image capture device 14. The image capturing device 14 may capture location (as well as orientation, shape, and color) data into a form suitable for storage in the data log. In some embodiments, the image capturing device 14 may transmit the captured data directly to a remote system (e.g., a laptop computer, or server, or virtual server in the “cloud”, or multiple servers e.g., in the “cloud”) by way of a network. Persons skilled in the art will recognize that a portable memory, e.g., a USB memory stick, may also be used for such data transmission. An application running on the image capturing device 14 or on the remote system in communication with the image capturing device 14 may integrate the location data sets in the data log to form a three-dimensional internal model representation. This integration or mapping may be performed on the image capturing device 14, the remote system, or on a combination of the two. The image capturing device 14 may also acquire a textural data to generate textures for the model representation/map.

### Flooring Photo-Digitizing Sectional Method

The aim of this method is to divide a surface area, which in certain embodiments may be a marine vessel, into easy to photograph sections that can then be dealt with one at a time according to the following steps:

Step One includes removing anything from the surface area that does not need to be there, (e.g., in the context of photo-digitizing the surface of the marine vessel, this includes removing any seats, coolers etc.). Thereby, all obstructions 16 can be identified as non-movable or intrinsic hardware of the surface area when rendering a model thereof. Then, a user would completely outline the perimeter of the surface area using boundary marker 12 that defines the boundary or bounds of the surface area. The boundary marker 12 may be dot tape that adheres to the surface of the surface area. Small breaks in the boundary marker 12 (dot tape) for defining corners are fine though the user should avoid large gaps. For portions of the surface area where it is difficult to place the dot tape on the perimeter (e.g., wherein non-skid meets the sides of the boat) it is acceptable to place the boundary marker 12 approximately one to two inches off the outer edge.

Step Two includes the user deciding how to divide the surface area into subsections 10 by placing boundary marker 12 within the perimetral boundary. The surface area is divided up according to three different types of subsections 10: unobstructed, partially obstructed, and wholly obstructed subsections 10. The difference in the subsections 10 is based on how they are viewed from overhead: in certain embodiments, an unobstructed section 10 can be seen completely when viewed from overhead (e.g., in the context of photo-digitizing a surface of a marine vessel, an unobstructed view may be the swim platform, rear deck, etc.); a partially obstructed subsections 10 has a significant portion that cannot be seen (e.g., in the context of photo-digitizing the surface of the marine vessel, typically a seating area that overhangs the floor); and wholly obstructed subsections 10 are completely blocked when viewed from above (e.g., in the context of photo-digitizing the surface of the marine vessel, the wholly obstructed subsections 10 may be the helm stations). Just to be clear, there may be multiple, say partially obstructed subsections 10 divided out of one environment or surface area.

The user may first define wholly obstructed areas first, and surround those with the boundary marker 12 on all sides The user continues to section off the surface area using the boundary marker 12 keeping subsections 10 to no larger than approximately four feet by four feet and making sure not to cover up hardware or other infrastructure with the boundary marker 12. Subsections 10 do not have to just be rectangles, they can have angled sides, etc. For partially obstructed subsections 12, the user may section off the obstructed area into its own subsection 10 using boundary marker 12. Subsections 10 can be smaller than 4′×4′ but should not be larger. Each subsection 10 must be surrounded by the boundary marker 12 on at least three sides, but four sides should be defined whenever possible.

Location data acquisition is Step Three, which includes taking photographs of each subsection 10 from predetermined vantage points. Location acquisition may be accomplished through an image capture device 14, i.e., a mobile computing device with a camera, though a digital camera may also be compatible with one of the methods contemplated herein). The image capture device 14 captures a plurality of images (“location frames”) for each subsection 10 in a predetermined sequence of preconfigured types of images/views, wherein this predetermined sequence and/or images views is a function of type of subsection 10 (unobstructed, partially obstructed, and wholly obstructed view types). The best order of subsections 10 in which to acquire location data, as opposed to randomly, is a function of the subsections 10 relative contiguity.

Prior to location data acquisition, the user may place a numbered marker 30 somewhere on each subsection 10 visible to the image capture device 14 to track subsections 10. Also prior to the data acquisition phase, the user places the orientation tool 20 in the subsection 10 to be image captured so that the orientation tool 20 is stationary and visible to the image capture device 14.

For unobstructed subsections 10, the data acquisition includes capturing the numbered marker 30 as they capture images from each of the sides of subsection 10, and another image (“location frame”) from a top plan (overhead) view, as illustrated in FIG. 5. Where, in each location frame, all boundary edges (defined by the boundary marker 12) are visible and that the orientation tool 20 is also visible in at least three images.

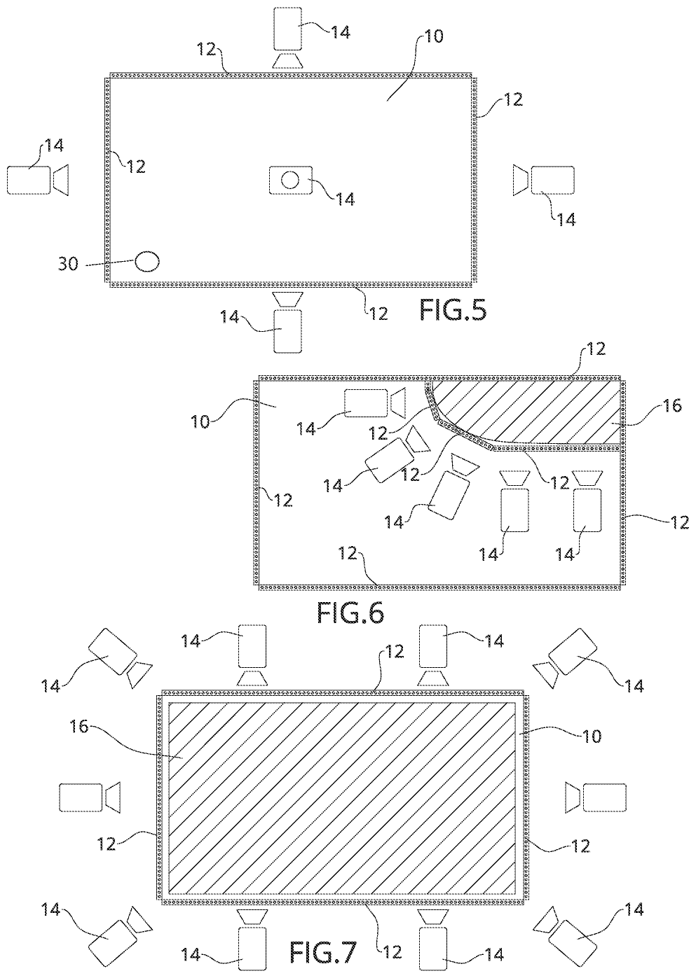

For partially obstructed subsections 10, the data acquisition includes capturing the numbered marker 30 when capturing each image of each side of the subsection 10, and another image/location frame from a top plan view, and a plurality of isometric/perspective images are also captured, as illustrated in FIG. 6. Where in each location frame all boundary edges (defined by the boundary marker 12) are visible and that the orientation tool 20 is also visible in at least three images.

For wholly obstructed subsections 10, the data acquisition includes capturing the numbered marker 30 when capturing each image of each side of the subsection 10, and another image from a top plan view, and a plurality of isometric/perspective images are also captured, as illustrated in FIG. 6. Where in each location frame all boundary edges (defined by the boundary marker 12) are visible and that the orientation tool 20 is also visible in at least three images.

The location data acquired through the above process may be received by a mapping module, which includes a photogrammetry software program, wherein the location data set of each subsection 10 is extracted, specifically the three-dimensional center of each location points 11 and/or 13, for utilization in a computer-aided design program for rendering a three-dimensional model of the surface area. In one embodiment, each location film and associated location data set is aligned and fitted or stitched together using the location points of adjoining or contiguous subsections 10, which may be represented by said location points 11 and 13 (i.e., through alignment of location points along a shared boundary marker 12. The complete model can now be used as a template which can be drawn over the complete design.

Furthermore, in certain embodiments, the orientation tool 20 is shaped the way it is because it works to define an x and a y axis so that the photogrammetric software “orients” image capturing device (e.g., camera) 14 and/or determines its three-dimensional position when the image was captured. The orientation tool 20 may require a plurality of targets or reticles 22 and be spread out in the field of view of the image capturing device 14. In certain embodiments, the orientation tool 20 has seven targets/reticles 22 for enabling the photogrammetric software to orient the image capturing device 14 position while also defining the x and y axis. This works to save time while designing and helps eliminate human error.

The boundary marker 12 may be dot tape containing a specific arrangement of dots 11 and crosses 13. The three-dimensional locations of the dots 11 are used in conjunction with the crosses 13 to define virtual planes via the photogrammetric software.

If the orientation of the tool or pictures initially fails during software processing, the present invention contemplates manually using the dots to achieve the orientation. Because the dots and crosses have a pattern, the present invention can locate a specific dot from one picture on any other picture.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the terms “align” and “continuous” means parallel, substantially parallel, or forming an angle of less than 15.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “contiguous” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A method of acquiring photogrammetric data, the method comprising:
defining a plurality of subsections of the surface area with boundary markers;
placing an orientation tool within one of the plurality of subsections; and
capturing, by way of an image capturing device, a plurality of images of one of the plurality of subsections, wherein a quantity and vantage points of the plurality of images for each subsection is based on whether the subsection is an unobstructed subsection, a partially obstructed subsection, or a wholly obstructed subsection.

2. The method of claim 1, wherein each subsection is surrounded on at least three sides.

3. The method of claim 2, further defining a boundary of the surface area with the boundary marker.

4. The method of claim 1, wherein the unobstructed subsection is defined by approximately zero percent of circumscribed surface having an obstruction thereon.

5. The method of claim 4, wherein the partially obstructed subsection is defined by approximately ten to ninety percent of circumscribed surface having an obstruction thereon.

6. The method of claim 5, wherein the wholly obstructed subsection is defined by approximately one hundred percent of circumscribed surface having an obstruction thereon.

7. The method of claim 6, wherein the wholly obstructed subsection is defined by approximately one hundred percent of circumscribed surface having an obstruction thereon.

8. The method of claim 7, further comprising placing a numbered marker within each of the plurality of subsections.

9. The method of claim 8, wherein the plurality of subsections comprises at least one unobstructed subsection, at least one partially obstructed subsection, and at least one wholly obstructed subsection.

10. The method of claim 9, wherein the boundary marker comprises location data points.

11. The method of claim 10, further comprising a photogrammetry software application configured to stitch together the plurality of subsections by aligning location data points of contiguous subsections.
